(19) United States
(12) Patent Application Publication
(10) Pub. No.: US 2023/0309462 A1
(43) Pub. Date: Oct. 5, 2023

(54) Potting Accessory, Plant Pot, and Planting Method

(71) Applicant: Paul J. Carbajal, Vancouver, WA (US)

(72) Inventor: Paul J. Carbajal, Vancouver, WA (US)

(21) Appl. No.: 18/191,703

(22) Filed: Mar. 28, 2023

Related U.S. Application Data
(60) Provisional application No. 63/324,996, filed on Mar. 29, 2022.

(51) Int. Cl. A01G 9/029

(52) U.S. Cl. CPC A01G 9/0299

(57) ABSTRACT

A potting accessory, corresponding plant pot, and corresponding method can include an insert that is removably insertable into a plant pot or outer shell. The insert includes a bottom portion and two or more lateral portions contiguous with the bottom portion, configured to be oriented substantially along an interior bottom and one or more interior lateral surfaces of the plant pot, respectively. The potting accessory also includes two or more handles configured to be held by a human. A mechanical connection of the handles to the respective lateral portions allows human hand(s) to situate the insert within the plant pot and to remove the insert from the plant pot. Embodiments allow for ease of transplanting and prevention of damage to plant pots, and to seedlings and other plants, during a transplanting process.

### RELATED APPLICATION

This application claims the benefit of U.S. Provisional Application No. 63/324,996, filed on Mar. 29, 2022. The entire teachings of the above application are incorporated herein by reference.

### BACKGROUND

In the process of transplanting a seedling from a plant container (plant pot) to another pot or into the ground, it is desirable to avoid breaking or otherwise damaging roots or other portions of the seedling. Toward the purpose of avoiding plant damage, a usual practice when transplanting from a pot is to turn the pot sideways or upside down and to attempt to remove the plant from the pot by pushing on the bottom of the pot, gently pulling the plant, and the like, followed by attempting to place the plant into a hole in the ground as carefully as possible. As an alternative, peat pods and pots have been marketed.

### SUMMARY

Turning a plant pot sideways or upside down, followed by pushing or pulling a plant out of the pot, still can result in damage, both to the plant structure and also to the pot. Furthermore, peat pods and peat pots can be very restrictive on the development of a root ball of a plant.

Accordingly, improved structures and methods are needed for planting and transplanting seedlings and other plants for which pots are used.

Embodiments described herein generally relate to potting accessories, plant pots, and corresponding methods that allow for removing a seedling or other plant from a plant pot easily, cleanly, and with little or no damage to a plant pot or to the roots or other structures of a seedling or other plant that is being transplanted. Embodiments described herein can allow for ease of transplanting, ease of re-use and recycling of pots and related accessories, and prevention of damage to pots and plants during transplanting. Furthermore, embodiments allow for maximized root ball growth without the restriction of peat pods and peat pots.

In one particular embodiment, a potting accessory includes an insert that is configured to be removably insertable into a plant pot. The insert includes a molded bottom portion configured to be oriented substantially along an interior bottom of the plant pot when the insert is situated within the plant pot. The insert also includes two or more molded lateral portions that are contiguous with the bottom portion. The molded lateral portions are configured to be oriented substantially along one or more interior lateral surfaces of the plant pot when the molded insert is situated within the plant pot. The potting accessory also includes two or more handles that are configured to be held by one or more human hands. Via mechanical connection of the two or more handles to the two or more respective lateral portions, the handles, held by the human, are configured to situate the insert within the plant pot and to remove the insert from the plant pot.

The two or more handles can be molded with the two or more lateral portions, respectively. However, in other embodiments, the two or more handles can be mechanically attached with the two or more molded lateral portions, respectively. The mechanical attachment may be via the handles being welded, bonded, bolted, or screwed, or otherwise mechanically attached to the molded lateral portions. The mechanical attachment may be a removable mechanical attachment.

In another embodiment, a potting accessory includes an insert and two or more handles. The insert is configured to be removably insertable into a plant pot, and the insert includes a bottom portion configured to be oriented substantially along an interior bottom of the plant pot when the insert is situated within the plant pot. The insert also includes two or more lateral portions contiguous with the bottom portion and configured to be oriented substantially along one or more interior lateral surfaces of the plant pot when the molded insert is situated within the plant pot. The bottom portion and the two or more lateral portions are formed from a monolithic strip of metal, sheet metal, aluminum, metal alloy, plastic, composite, polyvinyl chloride (PVC), vinyl, other polymer, or other monolithic strip of material that can withstand water and soil contact over a course of plant growth and to permit reuse of the insert. The two or more handles are configured to be held by one or more human hands and, via mechanical connection of the two or more handles to the two or more respective lateral portions, to situate the insert within the plant pot and to remove the insert from the plant pot.

Optionally, the two or more handles can also be formed from the same monolithic strip as the insert. However, as an alternative, the two or more handles can be mechanically attached with the two or more lateral portions, respectively, as described hereinabove in connection with the previously described embodiment potting accessory that includes a molded insert. The mechanical attachment may be a removable mechanically attachment.

In yet another embodiment, a plant pot includes an insert, two or more handles, and an outer shell. The insert can have any of the features described in connection with the previously described potting accessories. The two or more handles can also have features consistent with those described for the handles of the previously described putting accessories. The two or more handles are configured to be held by one or more human hands, and, via mechanical connection of the two or more handles to the two or more respective inner lateral wall portions, to situate the insert within the outer shell and to remove the insert from the outer shell. The outer shell includes at least two outer lateral wall portions and a joining member that is configured to join the at least two outer lateral wall portions to each other. Furthermore, in an inserted configuration with the insert situated within the outer shell, the insert and the outer shell together form the plant pot, which is configured to confine, substantially, soil therein.

In greater detail, the two or more inner lateral wall portions of the insert can be monolithic with the bottom portion, such as being formed from a monolithic strip of metal, sheet metal, tin, aluminum, metal alloy, plastic, composite, PVC, vinyl, or other polymer, for example. Alternatively, the bottom portion and the two or more inner lateral wall portions can be molded.

Optionally, the joining member of the outer shell can be a third lateral wall portion. The joining member can be monolithic with the at least two outer wall portions. As one alternative to being a third outer lateral wall portion, the joining member can be a strip of material, rod, or bracket that is configured to join the at least two outer lateral wall portions to each other. The joining member can be monolithic with the at least two outer wall portions, molded together with them, or attached with the at least two outer wall portions otherwise. The joining member and the at least two outer wall portions can be formed from a strip of metal, sheet metal, tin, aluminum, metal alloy, plastic, composite, PVC, vinyl, or other polymer. As an alternative, the joining member and the at least two outer wall portions can be molded.

The plant pot can further include at least two tabs that are contiguous with the at least two outer wall portions, respectively, where the at least two tabs can be configured, in the inserted configuration, to abut and to bound, at least partially, one of the inner lateral wall portions for motion constraints of the insert with respect to the outer shell. The at least two tabs can be monolithic with the at least two outer wall portions, respectively. In one example, the at least two outer wall portions, the joining member, and the at least two tabs are formed from a monolithic strip of metal, sheet metal, tin, aluminum, metal alloy, plastic, composite, PVC, the final, or another material as described hereinabove for a monolithic strip in other embodiments.

The two or more handles can be monolithic with the two or more respective inner lateral wall portions.

In a further embodiment, a potting method includes situating a removable insert into a plant pot, with a bottom portion of the removable insert oriented substantially along an interior bottom of the plant pot, and with two or more lateral portions that are contiguous with the bottom portion oriented substantially along one or more interior lateral surfaces of the plant pot. The method further includes adding potting material to the plant pot such that the removable insert partially borders the potting material. In addition, the method includes placing a seed or a plant into the potting material.

Situating the removable insert can include using two or more handles configured to be held by one or more human hands via mechanical connection of the two or more handles to the two or more respective lateral portions.

The removable insert, plant pot, and handles may have any of the features described in connection with other embodiments, including the potting accessories and plant pot described hereinabove, and the method can include consistent features accordingly.

In yet another embodiment, a planting method includes removing an insert from a plant pot. The removing is via one or more human hands holding two handles that are mechanically connected to two or more respective lateral portions oriented substantially along one or more interior lateral surfaces of the plant pot when the insert is situated within the plant pot. The removing the insert further includes removing a bottom portion that is contiguous with the two or more lateral portions and is oriented substantially along an interior bottom of the plant pot when the insert is situated within the plant pot. The method further includes extracting a plant from the insert through an opening between the two or more respective lateral portions of the insert.

As will be understood further in reference to the embodiments described above and to the drawings and description hereinafter, a further embodiment can include a planting, or transplanting, or plant extraction method corresponding to the plant pot described above with the insert, two or more handles, and outer shell. In particular, the method can include removing the insert from the outer shell via two or more handles, where the insert, two or more handles, and outer shell form the plant pot. The method can also include extracting a plant from the insert through an opening between the two or more respective lateral portions of the insert.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A is a perspective view illustration of an embodiment potting accessory that can be used with a plant pot, or as part of a plant pot.

FIG. 1B is a perspective view illustration of the potting accessory of FIG. 1A inserted into a plant pot.

FIG. 2 is a perspective view illustration of both the potting accessory of FIG. 1A, and of a monolithic strip from which the potting accessory can be formed in certain embodiments.

FIG. 3 is a top, perspective view of potting accessories, all of which are formed from monolithic strips, as illustrated in FIG. 2, particularly aluminum strips.

FIG. 4 is a side, perspective view of potting accessories of various sizes, formed in the same manner as those of FIGS. 2-3.

FIG. 5 illustrates various rectangular-shaped and round-shaped plant pots with potting accessories inserted therein according to example embodiments.

FIG. 6 illustrates how a seedling may be removed from a plant pot using a potting accessory as described in connection with FIGS. 1A-5.

FIGS. 7A-7B illustrate an embodiment plant pot formed from a potting accessory as described in connection with FIGS. 1A-6 (FIG. 7A) and an outer shell (FIG. 7B).

### DETAILED DESCRIPTION

A description of example embodiments follows.

“Interior lateral surface,” as used herein, includes substantially planar sides or other substantially smooth walls of a plant pot, such as a substantially round-walled pot, such as substantially cylindrically or conically shaped plant pots. Accordingly, an interior lateral surface can be a planar side of a rectangular pot, a relatively flat side with indentations or warped portions of the sides that still allow an insert and plant to be inserted into and removed from the plant pot, or a plant pot with curved interior lateral surface one or more curved interior lateral surfaces, such as with a substantially round or oval pot, for example.

“Monolithic,” as used herein, means formed or composed of material without joints or seams, but potentially exhibiting one or more bends imposed into the material.

“Confine, substantially,” “substantially confine,” “substantial confinement,” and similar phrases, as used herein, refer to conserving soil within, such as within a plant pot formed of the insert and the outer shell, to a physical extent and for a time needed for substantial growth of a seedling or other plant within the pot toward transplanting the seedling or other plant.

“Plant,” as used herein, includes a seedling, a mature plant, a root, a root ball, a cutting, or a tuber.

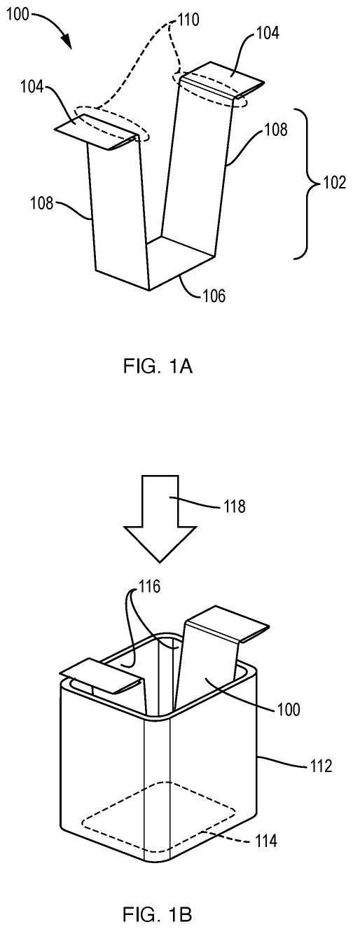

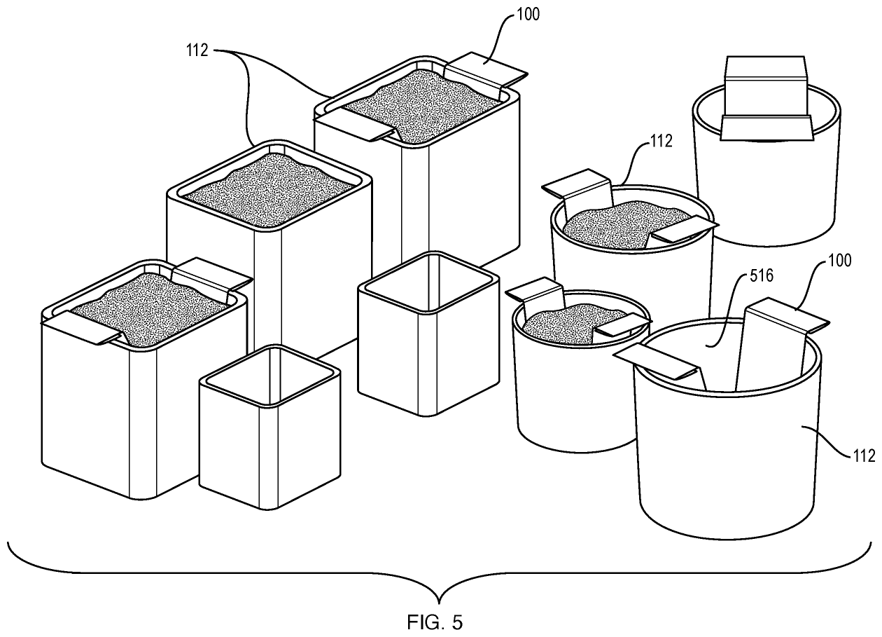

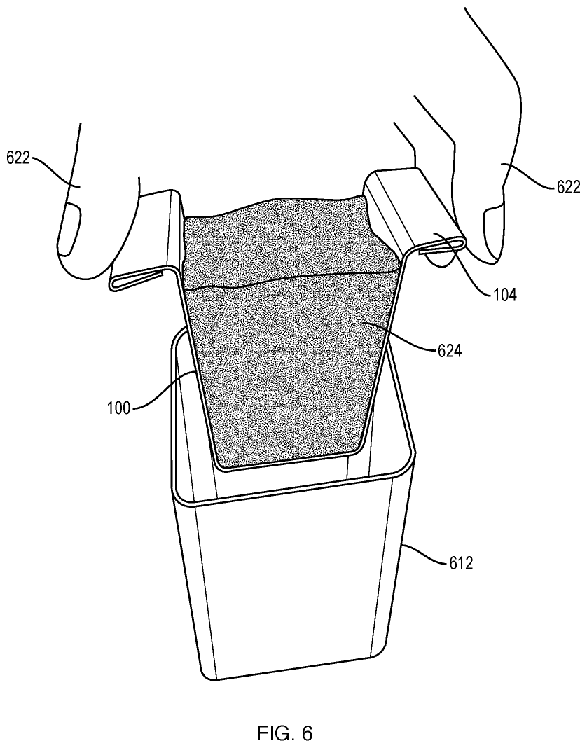

FIG. 1A is a perspective view illustration of an embodiment potting accessory 100, which includes both an insert 102 and two handles 104. The potting accessory 100 is configured to be removably insertable into a plant pot, as illustrated in FIG. 1B, and as illustrated in FIGS. 5-6, for example.

The insert 102 includes a bottom portion 106 that is configured to be oriented substantially along an interior bottom 114 of a plant pot 112 when the insert 102 is situated within the plant pot 112. The insert 102 also includes two lateral portions 108 that are contiguous with the bottom portion 106. The lateral portions 108 are also configured to be oriented substantially along respective lateral interior lateral surfaces 116 of the plant pot 112 when the insert is situated within the plant pot, as illustrated in FIG. 1B.

The two handles 104 are mechanically connected to the two lateral portions 108, respectively. Via the mechanical connections, one or more human hands can hold the two handles 104, as illustrated in connection with FIG. 6, in order to situate the insert 102 within the plant pot 112 and also to remove the insert 102 from the plant pot 112.

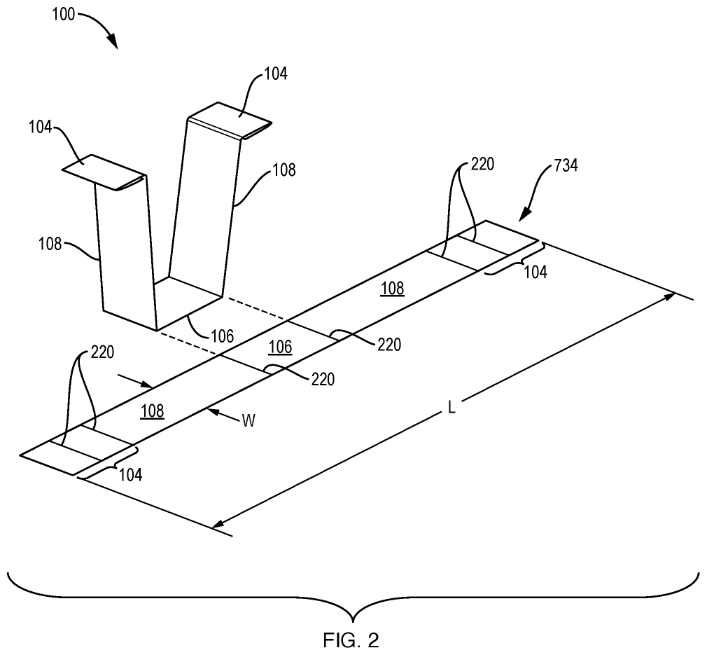

The bottom portion 106 and lateral portions 108 can be molded, in particular molded together as one molded part. Optionally, the handles 104 can also be molded, such as being molded together with the bottom portion 106 and lateral portions 108 to form one solid potting accessory 100. In this case, the mechanical connection 110 between the handles 104 and the lateral portions 108 is simply a curved or angled portion of the molded potting accessory 100. As an alternative, the two or more handles can be mechanically attached with the two or more lateral portions, including the option of removable attachment, via a weld, a chemical bond, screws, bolts, or any other means sufficient to secure the handles to the lateral portions 108 for insertion and removal of the potting accessory 100 from the plant pot 112. However, as an alternative to molding the potting accessory or portions thereof, the bottom portion 106 and the two lateral portions 108 can be formed from a monolithic strip of material that is capable of substantially confining soil without disintegration during a period of growth of a plant. Such a monolithic strip of material can include metal, sheet metal, 10, aluminum, metal alloy, plastic, composite, PVC, vinyl, or other polymer, for example. Construction of the potting accessory 100 from a monolithic strip is illustrated further hereinafter in connection with FIG. 2.

In the case of molded embodiments, as an example, many materials such as plastic, vinyl, and other polymer products can be manufactured by injection mold cast, already with bends, shape, and size. For molded embodiments, advantageously no bending process may be needed to achieve a shape consistent with the described embodiments.

It should be understood that the potting accessory 100 in FIGS. 1A-1B can have inserts 102 with more than two lateral portions 108. In one example, the lateral portions 108 shown in FIG. 1A may debate may be divided, each of the lateral portions 108, into two strips oriented laterally, both connected and contiguous with the bottom portion 108. Nonetheless, it is preferable for the insert 102 to include two, substantially planar lateral portions 108 that will allow for secure insertion and removal of the potting accessory with soil and a plant situated therein, and also smooth extraction of the plant from the insert through an opening between the two or more respective lateral portions of the insert, such as through one of the open sides defined by the insert 102 in FIG. 1A.

FIG. 1B shows the potting accessory 100 of FIG. 1A removably inserted into, and situated within, the plant pot 112 via an insertion motion 118.

FIG. 2 is a perspective view illustration of the potting accessory 100, together with a monolithic strip 734 of material from which the potting access three 100 can be optionally formed. In particular, the monolithic strip 734 has a strip width W and the strip length L, as illustrated. Various bends 220 can be formed in the monolithic strip via bending the strip around a corner, heating and then bending the strip and allowing the heated bend portion of the strip to harden again, etc.

Two bends 220 can be used to join the bottom portion 106 where the bottom portion 106 meets the two lateral portions 108. Furthermore, as illustrated in this particular case, the handles 104 can be formed also as from sections of the monolithic strip 734 via bends. In particular, an aluminum or other metal monolithic strip 734 can be have bends 220 applied at each side of the monolithic strip 734 in order to form the handles 104 with an extra fold at extremities of the handles. This forms a rounded edge that is not sharp and is safer for handling by human hands.

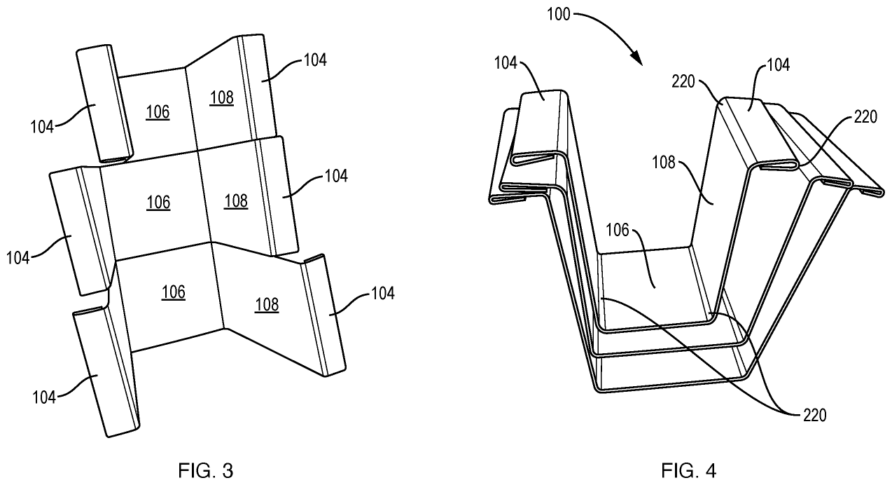

Examples of the potting accessory 100 formed in this manner from monolithic strips of aluminum are shown in FIGS. 3-6, for example. Nonetheless, in alternative embodiments, the handles are mechanically attached, such as removably mechanically attachable, with the two lateral portions 108, such as via screws, bolts, welding, adhesive bonds, melt bonding, or chemical bonding, and the like. In manufacturing metal-based embodiments, no heat will be needed for bending many embodiments. For example, 0.027 inch thick aluminum or painted metal can be easily bent to produce the bends 220 by hand break or by using a break machine. Nonetheless, it should be understood that a wide variety of thickness for monolithic strips can be used, such as 0.0038 inch material and also materials that are much thicker than 0.027 inch. Thickness of strip material can vary based on size of pot and expected weight of plant and soil, for example. A manufacturing method based on general manufacturing methods used for other products can easily be understood by those of skill in the industrial manufacturing arts for each particular material.

Example lengths and widths of monolithic strips are as follows. Nonetheless, it should be understood that many other sizes and shapes are consistent with embodiments, and strip dimensions can vary depending on the strip material, pot shape, whether the handles 104 are formed together with the insert, plant type, etc. In the following list, “ ” “indicates inches.
Small: 1½” width×9½″ length
Medium: 1¾″ width×11⅞″ length
Large: 2¼″ width×11⅞″ length
One gallon: 3½″ width×19½″ length

FIG. 3 illustrates three different potting accessories formed from an aluminum monolithic strip as exemplified in FIG. 2. The three different potting accessories shown in FIG. 3 can be used for round-sided or flat-sided pots of various sizes, as illustrated further in FIG. 5.

FIG. 4 shows several potting accessories 100 of various sizes, formed from respective monolithic strips of aluminum, in varying sizes.

FIG. 5 shows potting accessories 100 of various sizes, such as those shown in FIGS. 3-4, inserted into various rectangular- and round-shaped plant pots 112. As will be understood from the description hereinabove and from FIG. 5, a rounded plant pot 112 can be considered to have a single, continuous interior lateral surface 516. As illustrated in FIG. 5, and as will be noted from the description above, even where a potting accessory 100 has two flat-sided lateral portions 108, such a potting an accessory 100 can be adequately used in a round-walled pot that has that is considered to have a single interior lateral surface 560. Thus, in this case, both lateral portions 108 are considered to be oriented substantially along the single, rounded, interior lateral surface 516 of the rounded walled plant pots.

FIG. 6 shows a potting accessory 100, formed from an aluminum monolithic strip as described in connection with FIGS. 2-5, being removed from a plant pot 612 along with soil 624. A plant, such as a seedling, a root ball, or other plant can be positioned in the soil 624 and extracted from the potting accessory 100 after removal from plant pot 612.

FIG. 6 shows a single human hand 622 removing the potting accessory 100 from the plant pot 612 via the handles 104. More specifically, fingers of a human hand 622 are shown in FIG. 6. Nonetheless, embodiments can enable two human hands to grab respective handles 104 in order to remove the potting accessory 100 from the plant pot 612.

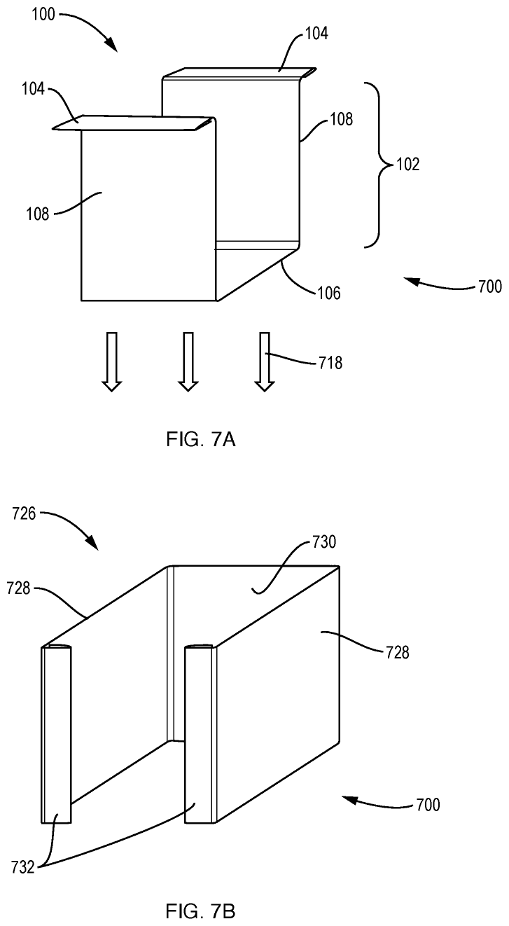

FIGS. 7A-7B are perspective view illustrations of components forming a plant pot 700 in combination. These components of the plant pot 700 include a potting accessory 100 as illustrated in FIG. 1A and an outer shell 726. When the potting accessory 100 is removably inserted into the outer shell 726, via a removable insertion action 718 as illustrated, the potting accessory 100 and the outer shell together form the plant pot 700, which is configured to confine, substantially, soil therein.

In greater particular, the plant pot 700 includes the insert 102 of the potting accessory 100, which includes the bottom portion 106 and the two lateral portions 108. In this embodiment, the lateral wall portions can be referred to as herein as “inner lateral wall portions” in order to distinguish them from parts of the outer shell 726 that will be described hereinafter. Optionally, the plant pot 700 may include the entire potting accessory 700, including the handles 104 with the insert 102, whether molded together with the insert 102 or formed from a common monolithic strip with the insert 102, or whether attached to the insert 102. Accordingly, the potting accessory 100 of the plant pot 700 can include any of the features or characteristics described in connection with other embodiments, including FIGS. 1A-6.

The two handles 104 are configured to be held by one or more human hands, and, via mechanical connection of the two or more handles to the two or more respective inner lateral wall portions 108, to situate the insert within the outer shell 726, via the removable insertion action 718.

The outer shell 726 includes at least two outer lateral wall portions 728 and a joining member 730 that is configured to join the at least two outer lateral wall portions 728 to each other. In the embodiment of FIG. 7B, the outer shell 726 is a third outer lateral wall portion that joins the two outer lateral wall portion 728. However, in other embodiments, this joining number 730 can be a bar, a bracket, etc.

It will be understood that the joining member can be monolithic with the at least two outer wall portions 728. The joining member 730 and the at least two outer wall portions 728 can be formed from a strip of metal, sheet metal, tin, aluminum, metal alloy, plastic, composite, PVC, vinyl, other polymer, or materials with similar properties that permit substantial soil confinement during a growth period of a plant without substantial degradation due to water, soil, etc.

In the embodiment of FIGS. 7A-7B, the outer shell 726 further has optional tabs 732 that are contiguous with the two outer wall portions 728, respectively. The two tabs 732 are configured, in the inserted configuration, to abut and to bound, partially, one of the inner lateral wall portions 108. Thus, the tabs 730 to provide, in the inserted configuration, advantageously, for motion constraint of the insert 102 with respect to the outer shell 726. The tabs 732, then, can assist in the plant pot 700 substantially confining soil by holding together tightly more tightly, for example.

In an example case of a potting accessory 100 (including insert 102) formed from a monolithic strip with dimensions 2¼″ width×9¼″ length, an example outer shell as illustrated in FIG. 7B can be formed from a monolithic strip having dimensions 2¼″ width×9 1/16″ length.

In other embodiments, the optional tabs 732 can be replaced by a full outer lateral wall portion, which forms an additional joining member, similar to the joining member 730. Nonetheless, other features may also be included, including brackets, strips, etc. replacing the tabs 732.

Various embodiment potting accessories, plant pots, and related methods can provide for simple, uniquely designed seedling starter pots with removable inserts. Embodiments can be built in any size to fit any pre-existing plant pot effectively.

In order to use various embodiments, particularly the embodiment potting accessories described above, the inserts can be placed into empty pots, soil can be added into the pots on top of the inserts, a seed, root or other plant can be planted, and germination and sprouting or other growth can be awaited.

Once a plant is ready for transplantation, a person can grab the insert via the handles of the potting accessory and pull the potting accessory straight up and out of the plant pot or outer shell, easily removing the root ball, plant, and insert without damage to the plant or to the pot. Use of embodiments is quite advantageous in protecting and preventing damage to plastic pots, for example, from the traditional pressing and smashing of the pot to remove the plant. Embodiments also protect the plant from damage, allowing removal of the plant without tilting or flipping the pot.

While example embodiments have been particularly shown and described, it will be understood by those skilled in the art that various changes in form and details may be made therein without departing from the scope of the embodiments encompassed by the appended claims.

What is claimed is:

1. A potting accessory comprising:
an insert configured to be removably insertable into a plant pot, the insert including:
a molded bottom portion configured to be oriented substantially along an interior bottom of the plant pot when the insert is situated within the plant pot; and
two or more molded lateral portions contiguous with the bottom portion and configured to be oriented substantially along one or more interior lateral surfaces of the plant pot when the molded insert is situated within the plant pot;
and
two or more handles configured to be held by one or more human hands and, via mechanical connection of the two or more handles to the two or more respective lateral portions, to situate the insert within the plant pot and to remove the insert from the plant pot.

2. The potting accessory of claim 1, wherein the two or more handles are molded with the two or more lateral portions, respectively.

3. The potting accessory of claim 1, wherein the two or more handles are mechanically attached with the two or more lateral portions, respectively.

4. A potting accessory comprising:
an insert configured to be removably insertable into a plant pot, the insert including:
a bottom portion configured to be oriented substantially along an interior bottom of the plant pot when the insert is situated within the plant pot; and
two or more lateral portions contiguous with the bottom portion and configured to be oriented substantially along one or more interior lateral surfaces of the plant pot when the molded insert is situated within the plant pot,
wherein the bottom portion and the two or more lateral portions are formed from a monolithic strip of metal, sheet metal, tin, aluminum, metal alloy, plastic, composite, PVC, vinyl, or other polymer;
and
two or more handles configured to be held by one or more human hands and, via mechanical connection of the two or more handles to the two or more respective lateral portions, to situate the insert within the plant pot and to remove the insert from the plant pot.

5. The potting accessory of claim 4, wherein the two or more handles further are formed from the monolithic strip.

6. The potting accessory of claim 4, wherein the two or more handles are mechanically attached with the two or more lateral portions, respectively.

7. A plant pot comprising:
an insert;
two or more handles; and
an outer shell,
wherein the insert is configured to be removably insertable into the outer shell, the insert including a bottom portion and two or more inner lateral wall portions contiguous with the bottom portion,
wherein the two or more handles configured to be held by one or more human hands, the two or more handles further configured, via mechanical connection of the two or more handles to the two or more respective inner lateral wall portions, to situate the insert within the outer shell and to remove the insert from the outer shell,
wherein the outer shell includes at least two outer lateral wall portions and a joining member that is configured to join the at least two outer lateral wall portions to each other, and
wherein, in an inserted configuration with the insert situated within the outer shell, the insert and outer shell together form a plant pot configured to confine, substantially, soil therein.

8. The plant pot of claim 7, wherein the two or more inner lateral wall portions are monolithic with the bottom portion.

9. The plant pot of claim 8, wherein the bottom portion and the two or more inner lateral wall portions are formed from a strip of metal, sheet metal, tin, aluminum, metal alloy, plastic, composite, PVC, vinyl, or other polymer.

10. The plant pot of claim 8, wherein the bottom portion and the two or more inner lateral wall portions are molded.

11. The plant pot of claim 7, wherein the joining member of the outer shell is a third outer lateral wall portion.

12. The plant pot of claim 7, wherein the joining member is monolithic with the at least two outer wall portions.

13. The plant pot of claim 12, wherein the joining member and the at least two outer wall portions are formed from a strip of metal, sheet metal, tin, aluminum, metal alloy, plastic, composite, PVC, vinyl, or other polymer.

14. The plant pot of claim 12, wherein the joining member and the at least two outer wall portions are molded.

15. The plant pot of claim 7, further comprising at least two tabs that are contiguous with the at least two outer wall portions, respectively, the at least two tabs configured, in the inserted configuration, to abut and to bound, at least partially, one of the inner lateral wall portions for motion constraint of the insert with respect to the outer shell.

16. The plant pot of claim 15, wherein the at least two tabs are monolithic with the at least two outer wall portions, respectively.

17. The plant pot of claim 16, wherein the at least two outer wall portions, the joining member, and the at least two tabs are formed from a monolithic strip of metal, sheet metal, tin, aluminum, metal alloy, plastic, composite, PVC, vinyl, or other polymer.

18. The plant pot of claim 7, wherein the two or more handles are monolithic with the two or more respective inner lateral wall portions.

19. A potting method comprising:
situating a removable insert into a plant pot, with a bottom portion of the removable insert oriented substantially along an interior bottom of the plant pot, and with two or more lateral portions that are contiguous with the bottom portion oriented substantially along one or more interior lateral surfaces of the plant pot;
adding potting material to the plant pot such that the removable insert partially borders the potting material; and
placing a seed or a plant into the potting material.

20. The method of claim 19, wherein situating the removable insert includes using two or more handles configured to be held by one or more human hands via mechanical connection of the two or more handles to the two or more respective lateral portions.

21. A planting method comprising:
removing an insert from a plant pot, wherein the removing is via one or more human hands holding two handles that are mechanically connected to two or more respective lateral portions oriented substantially along one or more interior lateral surfaces of the plant pot when the insert is situated within the plant pot, wherein removing the insert further includes removing a bottom portion that is contiguous with the two or more lateral portions and is oriented substantially along an interior bottom of the plant pot when the insert is situated within the plant pot; and
extracting a plant from the insert through an opening between the two or more respective lateral portions of the insert.
